(19) United States
(12) Patent Application Publication
(10) Pub. No.: US 2006/0178903 A1
(43) Pub. Date: Aug. 10, 2006

(54) Method and system for converged communications directory search and advertising services

(75) Inventor: Jose L. Cruz-Rivera, Rincon, PR (US)

Correspondence Address: AKIN GUMP STRAUSS HAUER & FELD, LLP, P O BOX 688, DALLAS, TX, 75313-0688, US

(73) Assignee: Commoca, Inc., Mayaguez, PR (US)

(21) Appl. No.: 11/335,025

(22) Filed: Jan. 19, 2006

Related U.S. Application Data
(60) Provisional application No. 60/646,025, filed on Jan. 21, 2005.

(51) Int. Cl. G06Q 99/00

(52) U.S. Cl. 705/1

(57) ABSTRACT

A method and system for end-to-end delivery of directory search and advertising services is implemented on a converged communications content distribution architecture. Merchants may directly engage the content distribution platform to schedule, target, and provide multimedia content for their directory listings. Service providers enable access to end-users via converged communications terminals, such as multimedia-enabled VoIP phones, and provide all transaction and usage reporting.

### CROSS REFERENCE TO RELATED APPLICATIONS

This application is related to the following commonly owned copending U.S. patent application: Provisional Application Ser. No. 60/646,025, entitled “Converged Communications Directory Search and Advertising Services and Methods,” filed Jan. 21, 2005, and claims the benefit of its earlier filing date under 35 U.S.C. § 119(e).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A MICROFICHE APPENDIX

Not applicable.

### TECHNICAL FIELD

The present invention relates to the field of an Internet phone system, and more particularly to converged communications relating to a directory search and advertising services.

### BACKGROUND INFORMATION

Recently, multimedia communication in which voice, video and data information are transmitted and received using the Internet Protocol (IP) is carried over an IP network. A phone, referred to herein as an “IP phone” or more generally as a “converged communications terminal,” may be connected directly to the IP network over which a multimedia phone exchange system can be constructed. An IP phone is a telephone which can operate and execute voice communication in the same way as conventional telephones either via a Plain Old Telephone System (POTS) or an IP network. Further, the IP phone can use the IP network for data applications. For example, IP phones may be connected to an IP network, such as a local area network, in an office environment thereby using the network as a private telephone network circuit and as a data exchange network. In another example, IP phones may use a wide area network, e.g., Internet, to communicate with other properly configured IP phones for data-voice exchanges. In another example, IP phones may use a data network for transactional data applications and the POTS network for voice.

IP phones currently have features similar to those found in traditional public switched telephone network (PSTN) phones such as call forwarding, call waiting, conference calls and so forth. Enhancements to these feature sets have been slow in coming, as market leaders in the “Voice over IP” (VoIP) telephony field have pursued an incremental approach to their product offerings, particularly because of the lack of computing power available in VoIP platforms. Currently, to ensure optimal user experience and cost-performance, VoIP platforms may have to be specifically designed for a target market area and software application (e.g., data-voice application) operating on the IP phone. By having to design and implement separate VoIP platforms for each application operating on the IP phone, the cost in operating different applications on an IP phone may be prohibitive.

VoIP equipment and systems have been deployed and managed by corporations over the last 10 years in the attempt to reduce the cost of voice services. The IP voice systems that are currently being deployed to corporate enterprise customers represent basic extensions in features and capabilities over what traditional PBX voice systems have offered for many years.

As VoIP technology has matured and evolved, dynamic new market opportunities are being created for service providers to deploy VoIP services that can increase their customer reach and resulting revenue growth opportunities. VoIP allows service providers to offer more cost effective voice services and value added functionality. Many service providers have already begun to rollout very basic VoIP services including: AT&T, Verizon, BellSouth, and others. The IP voice services being offered today are limited in functionality and primarily marketed as “cost saving” plans to consumers and businesses.

Today, VoIP technology is just reaching the point where telephony service providers can offer their customers more than just voice services at discounted rates. Both traditional voice providers (Verizon, SBC, etc.) and non-traditional providers (AT&T, TimeWarner Cable, Vonage) are looking for ways to increase their revenue through additional voice and data services enabled by VoIP. Similar to what has occurred in the cellular market; VoIP began with voice as the major application and is beginning the transition to convergence of voice and data applications.

A major potential market segment for VoIP is that of official search and contextual ad space. There are more than 23 million businesses in the U.S.A. alone, of these less than 2% advertise on-line on the Internet. In addition, 27% of all on-line searches are aimed at finding local services or businesses, while 2 out of 3 small and medium size businesses still rely heavily on the phone for sales leads. Of the 23 million businesses in the United States alone, 16 million are sole proprietorships without employees. There are 11 million businesses included in all Yellow Pages publications, of which 5 million pay to be listed and 1 million pay for additional coverage. A total of $15 billion is spent in Yellow Page listings: $2.5 billion is spent nationally (listings in 2+states, multiple books), $2.5 billion is spent independently (whereby 50% are duplications from public phone books) and $10 billion is divided between 80% simple listing and 20% display listings.

Current Internet-based Search Engine solutions fall short, since they lack specific knowledge of the consumer (end-user) and are distracted in their business focus on fighting for strategic domination of the PC desktop. Traditional business directories, such as the Yellow Page Books, on the other hand, have the necessary relationships with advertisers and consumers, but cannot provide sufficient information and interactive technology. Furthermore, searching through large books is inconvenient, as they are bulky, frequently outdated, and are not cost-effective for advertisers or service providers. Thus, there exists a substantial demand gap between what existing on-line search and advertising technology can provide, and the needs of a majority of businesses in this area; this demand gap is particularly widespread for smaller business operating in local markets.

Therefore, there is a need in the art for an IP phone configured with a VoIP platform that can support different applications operating on the IP phone. Also, there is a need in the art for an ability to develop, deliver and manage data-voice applications operating on an IP phone. Further, what is needed, is a method and system for converged communications relating to a directory search and advertising services, via a content distribution platform, that allows consumers, businesses, content owners, and service providers to leverage the benefits of converged data-voice applications.

### BRIEF SUMMARY OF THE INVENTION

The problems outlined above may at least in part be solved in some embodiments by a software platform in an IP phone having the ability to be used with different communication infrastructures such as broadband, wireless communication, POTS service. Further, the software platform is used in conjunction with a communications architecture, referred to herein as the Transaction Applications Delivery Services (TADS) communications architecture, that provides the ability to develop, deliver and manage data-voice applications operating on the IP phone. All of the elements of the TADS communications architecture are described in U.S. patent application Ser. No. 11/219,934, which is hereby incorporated by reference.

The present invention comprises a series of end-to-end services and methods, built on top of the TADS architecture, that enable directory search and advertising service delivery to converged communications terminals. The directory search and advertising services are digitally delivered via a content distribution platform that provides consumers, businesses, content owners, and service providers with converged data-voice applications. The present invention provides merchants the ability to engage the content distribution platform owners directly, via a web-based interface, to schedule, target, and provide multimedia content in directory listing services.

Various embodiments of the present innovation are enabled for providing services comprising:

“web search engine-like” search capability on a terminal;

user-aware “yellow pages” applications on a terminal;

one-touch call initiation;

no-contact transactions;

ability to save query results on the terminal;

delivery of multimedia advertisements to the terminals; and

priority listings of merchant information based on contextual data supplied by the merchant. The present invention also comprises a method for analyzing a geographic area for its profitability in rolling out and distributing a converged communications terminal infrastructure.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE SEVERAL VIEWS OF THE DRAWINGS

A better understanding of the present invention can be obtained when the following detailed description is considered in conjunction with the following drawings, in which:

FIG. 1 illustrates a system implementing a multi-layer fixed telephone system interacting with different communication infrastructures in accordance with an embodiment of the present invention;

FIG. 2 illustrates a typical hardware configuration of an application and server in accordance with an embodiment of the present invention;

FIG. 3 illustrates an embodiment of the present invention of a converged communications content distribution platform, based on a client-server communications model;

FIG. 4 illustrates an embodiment of the present invention of a converged communications content distribution server side elements;

FIG. 5 illustrates an embodiment of the present invention of a converged communications content distribution client side elements;

FIG. 6 illustrates an embodiment of the present invention of a converged communications content distribution architecture;

FIG. 7 illustrates an embodiment of the present invention of converged communications search and advertising services;

FIG. 8 illustrates an embodiment of the present invention of a converged communications content distribution architecture;

FIG. 9 illustrates a stakeholder view of a geographic area in an embodiment of the present invention; and

FIG. 10 illustrates an embodiment of the present invention of a method for analyzing roll-out and distribution models in a geographic area.

### DETAILED DESCRIPTION OF THE INVENTION

In the following description, numerous specific details are set forth to provide a thorough understanding of the present invention. However, it will be apparent to those skilled in the art that the present invention may be practiced without such specific details. In other instances, well-known circuits and software modules have been shown in block diagram form in order not to obscure the present invention in unnecessary detail. For the most part, details considering timing considerations and the like have been omitted inasmuch as such details are not necessary to obtain a complete understanding of the present invention and are within the skills of persons of ordinary skill in the relevant art.

Although the converged communication terminal of the present invention is described with reference to an Internet Protocol (IP) phone it is noted that the principles of the present invention may be applied to any Internet connected device, such as an Internet appliance. It is further noted that embodiments applying the principles of the present invention to such Internet connected devices would fall within the scope of the present invention.

The proposed invention consists of a series of services and methods that enable directory search and advertising service delivery to converged communications terminals via a content distribution platform that allows consumers, businesses, content owners, and service providers to leverage the benefits of converged data-voice applications. Data-voice applications are those that take advantage of voice over Internet Protocol (VoIP) infrastructures. A converged communications terminal is a communications device that has the capacity to integrate two or more of the following end-user services into a single device: voice, video, data. The terminal may be portable or fixed, operate on proprietary or open-standard-based wired or wireless communications infrastructures, use proprietary or open-source operating systems, and leverage VoIP infrastructures.

In one embodiment, the present invention is implemented using the TADS communications architecture, which supports the following high-level objectives:

Application and Content Transactions—TADS provides an integrated download and content management system which enables the delivery of software and content to enabled devices. The download manager supports the entire process of software provisioning, including the submission of content and applications from third-party developers, testing and certification of those applications, bundling, pricing, demographics-based targeted promotions, and delivery to enabled terminals.

Remote provisioning and support TADS includes the capability to remotely, provision, configure, or upgrade compatible devices. This enables providing online help support to users and reducing the need for on premise visits. Through this capability, service providers will be able to bring up new clients, push the latest software updates to the IP terminals, or remotely perform a move, add, or change to a customers system.

Content Presentation at Endpoints—TADS servers are aware of and process all voice and data before transmitting to the device. The servers communicate with the IP devices to determine the optimal delivery, compression, and formatting of the information to be displayed on the phone. This content optimization will maximize the service providers use of “on screen” real estate at the customer's premise.

Flexible interfacing—TADS uses open standard interfaces to enable quick and easy integration with a carrier's existing systems and third party equipment and software.

Reliability and scalability—all software components incorporate redundancy and load balancing to provide a very high level of service availability. To enable carrier grade reliability, the TADS servers route all voice and data traffic to other servers should it encounter any hardware or software failures. The system provides scalability simply through the addition of servers.

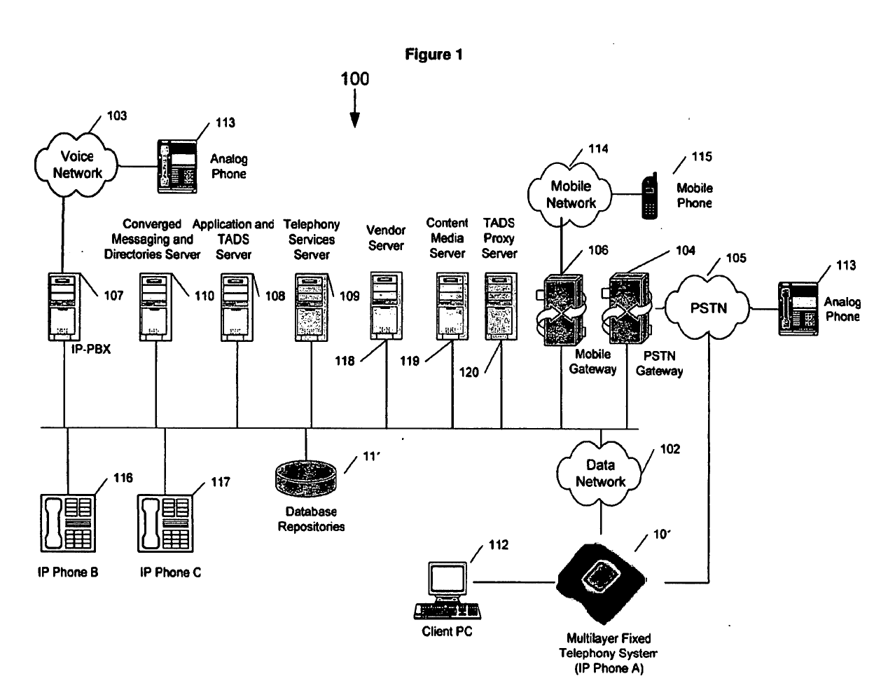

FIG. 1 illustrates a high level diagram of an embodiment of the present invention of a system 100 implementing a multi-layer fixed telephone system 101 interacting with different communication infrastructures. Referring to FIG. 1, system 100 allows multi-layer fixed telephone system 101 (referred to herein as a “IP phone A”, “IP Phone”, or more generally as a converged communications terminal) to interact with other entities over different communication infrastructures, such as data, voice, mobile and Public Switched Telephone Networks (PSTN) 102, 103, 114, 105, respectively, to provide telephony functions and run applications. The IP phone 101 is an embodiment of a converged communication terminal. In one embodiment, IP phone 101 may be coupled to a computer system 112, data network 102 and a Public Switched Telephone Network (PSTN) 105. IP phone 101 may communicate with third-party voice over IP (VoIP) terminals 116 and 117 (IP Phones B and C, respectively) via data network 102. IP phone 101 may further communicate with an analog phone 113 over PSTN 105. IP phone 101 may further communicate with analog phone 113 over voice network 103 via data network 102. Further, IP phone 101 may communicate with a mobile phone 115 over mobile network 114 via data network 102.

System 100 may further include a Public Switched Telephone Network (PSTN) Gateway 104 coupled to data network 102. PSTN gateway 104 may be configured to translate signaling and media between data network 102 coupled to IP phone 101 and PSTN 105. PSTN 105 may be coupled to conventional telephone 113. PSTN gateway 104 may allow IP phone 101 to communicate with standard analog telephones 113 in PSTN 105. System 100 may further include a mobile gateway 106 coupled between data network 102 and mobile network 114. Mobile gateway 106 may be configured to translate signaling and media between data network 102 and mobile wireless network 114. Mobile network 114 may be coupled to mobile telephone 115. Mobile gateway 106 may allow IP phone 101 to communicate with mobile phones 115 in wireless network 114. IP phone 101 may signal mobile gateway 106 in order to enable calls destined to mobile telephone 115 to be terminated on IP phone 101. System 100 may further include an Internet Protocol-Private Branch exchange (IP-PBX) 107 coupled to data network 102, voice network 103 and analog phones 113 or VoIP phone 116. IP-PBX 107 may be configured to interconnect voice and data networks 103, 102, respectively, in an enterprise environment and provide centralized call control functionality. System 100 may further include a telephony services server 109 coupled to data network 102. Telephony services server 109 may be configured to provide services that allow IP phone 101 to communicate with other analog and VoIP terminals and extend its range of available telephony features. System 100 may further include a converged messaging and directory server 110 coupled to data network 102. Converged messaging and directory server 110 may be configured to contain all the components necessary to provide the user with a unified converged platform to send and receive electronic and voice mail messages. In addition, server 110 may provide IP phone 101 with access to personal and public contact directories.

System 100 may further include a vendor server 118 coupled to data network 102. Vendor server 118 may be configured to allow end-users to access and purchase goods and services via IP phone 101. System 100 may further include a content and media server 119 coupled to data network 102. Content media server 119 may be configured to allow end-users access to media content via IP phone 101. System 100 may further include a TADS proxy server 120 coupled to data network 102. TADS Proxy Server 120 can be placed in front of two or more TADS servers to achieve load balancing and redundancy. System 100 may further include a database repository 111 coupled to data network 102. Database repository 111 may be configured to manage and provide IP phone 101 and servers 107, 108, 109, 110, 119 and 120 with data needed to perform their tasks. System 100 may further include an application server 108 coupled to data network 102. Application server 108 may be configured to contain the server side components (discussed further below) of client/server applications accessed through IP phone 101, such as the components of the Transactional Application Delivery System (TADS).

It is noted that FIG. 1 is illustrative and that not all of the components of system 100 were depicted for the sake of brevity (e.g., provisioning and configuration servers). It is further noted that system 100 is not to be limited in scope to the system disclosed and may be implemented with functionality pertinent to embodiments of the present invention.

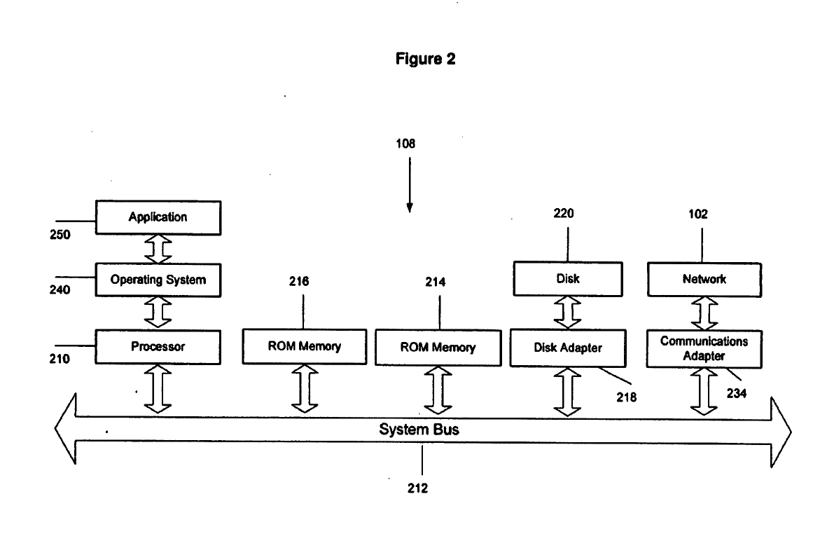

FIG. 2 illustrates a typical hardware configuration of server 108 (FIG. 1) which is representative of a hardware environment for practicing the present invention. Referring to FIG. 2, server 108 may have a processor 210 coupled to various other components by a system bus 212. An operating system 240, may run on processor 210 and provide control and coordinate the functions of the various components of FIG. 2. An application 250 in accordance with the principles of the present invention may run in conjunction with operating system 240 and provide calls to operating system 240 where the calls implement the various functions or services to be performed by application 250. Read only memory (ROM) 216 may be coupled to system bus 212 and include a basic input/output system (“BIOS”) that controls certain basic functions of server 108. Random access memory (RAM) 214 and disk adapter 218 may also be coupled to system bus 212. It should be noted that software components including operating system 240 and application 250 may be loaded into RAM 214 which may be server's 108 main memory. Disk adapter 218 may be an integrated drive electronics (“IDE”) adapter that communicates with a disk unit 220, e.g., disk drive. In FIG. 2, communications adapter 223 may also be coupled to system bus 212. Communications adapter 223 may interconnect bus 212 with an outside network 102 enabling server 108 to communicate with IP phone 101.

Embodiments of the present invention include implementations as a computer system programmed to execute the method or methods described herein, and as a computer program product. According to the computer system embodiments, sets of instructions for executing the method or methods may be resident in the random access memory 214 of one or more computer systems configured generally as described above. Until required by server 108, the set of instructions may be stored as a computer program product in another computer memory, for example, in disk drive 220 (which may include a removable memory such as an optical disk or floppy disk for eventual use in disk drive 220). Furthermore, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical or some other physical change.

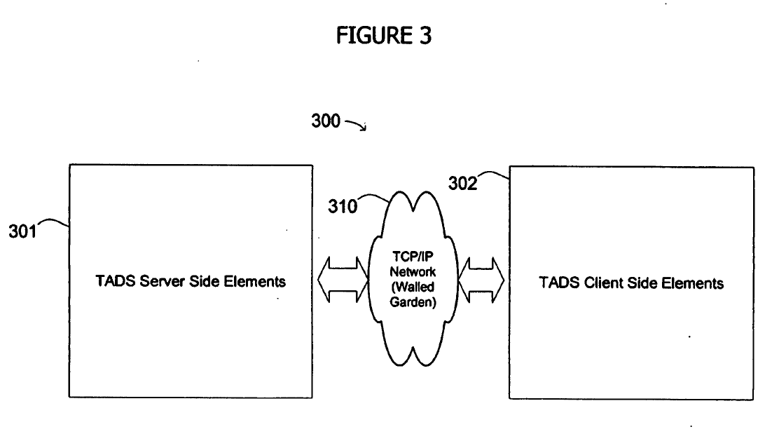

An illustrative embodiment of a converged communications content distribution platform, based on a client-server TADS communications model, that can be used to develop client converged communication terminal devices, such as IP Phone 101, that can support the distribution of value-added services to end-users is illustrated in FIG. 3.

Referring to the exemplary embodiment illustrated in FIG. 3, converged communications content distribution platform 300 is formed on the basis of a Transactional Application Delivery System (TADS) for service providers and/or third party developers and content providers to rapidly develop, deliver, and manage revenue generating and productivity enhancing data-voice applications for converged communications terminals 101. The present invention may be practiced with other functional application delivery architectures (not shown). The exemplary platform illustrated in FIG. 3 is built atop a so-called transactional application delivery system (TADS)—a closed (“walled garden”) proprietary client-server software platform, that enables merchants and content owners to rapidly develop, deliver, and manage revenue generating data-voice applications for converged communications terminals. Merchants in this context are considered business owners/operators, supplying consumers located within a geographic area with a product or a service. One example of a content owner (or content provider) is an entity that publishes a proprietary business directory, wherein the content refers to the directory listings of individual merchants ordered by category of business activity.

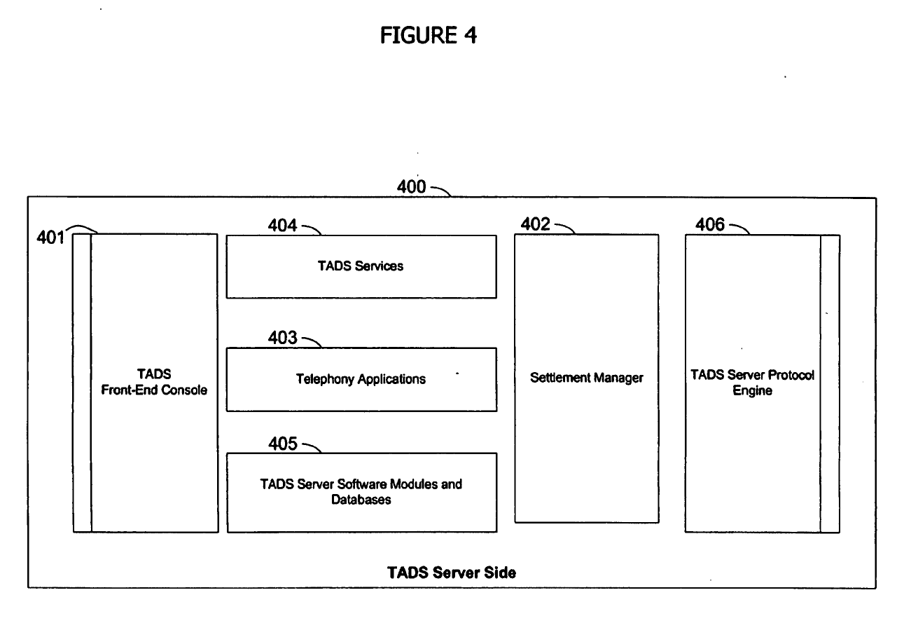

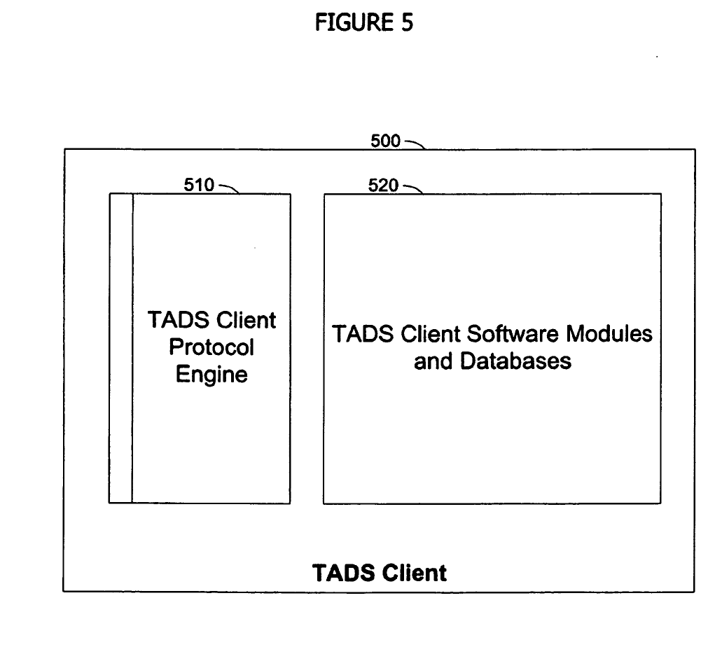

TADS is comprised of various Server Side and Client Side Elements that communicate with each other via a closed (walled garden) TCP/IP network. Data-voice applications are those that take advantage of voice over Internet Protocol (VoIP) and/or POTS/Broadband infrastructures. The exemplary application delivery system, TADS, may comprise various Server Side and Client Side Elements that communicate with each other via a closed (walled garden) TCP/IP network. As illustrated in FIG. 3, TADS server side elements 301 communicate with TADS client side elements 302, e.g., IP phones 101, via a closed TCP/IP data network 310, e.g., walled garden. In this context, a closed data network (walled garden) implies that access to the network is restricted by the owner of the infrastructure to specific devices or classes of devices. In one embodiment of the present invention, the walled garden is restricted to VoIP terminal devices, such as converged communication terminals 101. Converged communications content distribution platform 300 has built-in flexibility allowing it to evolve with advancements in hardware, software, protocols, thus providing an extensive platform for delivery of applications and content. A more detailed description of embodiments of platform 300 is provided below in association with FIGS. 4 and 5.

FIG. 4 illustrates an embodiment of the server side 301 of converged communication content distribution platform 300. In one exemplary embodiment that may be practiced with the present invention, TADS server side 400 comprises elements including a TADS Front-End Console 401 that allows merchants to submit content to the content distribution platform via a web-based interface (not shown). A TADS Server Protocol Engine 406 handles all communications using the TADS protocol on the server side for handling transactions, distributing advertisements, subscribing clients to distribution groups and delivering products to clients. The server side elements 400 may further comprise various Server software modules and databases 405 on top of which telephony applications 403 and converged voice-data applications and services may be constructed as TADS services 404. TADS server side elements 400 may further include a Settlement Manager 402 that maintains a log of all end-user actions during a converged communications session that can then be used to determine profit allocation throughout the value chain (merchants, content providers, service providers, and the owner of the content distribution platform) as well as to obtain valuable closed activity reports that may be used to drive new services and log valuable demographic data on all end-user transactions. A service provider may also be the owner of the content distribution platform, and provides the operational support for establishing and maintaining the network infrastructure. Further on the server side, a TADS heartbeat process (not shown) may inform other TADS-enabled devices about its processor load and other transient data by sending periodic heartbeat messages.

FIG. 5 illustrates an embodiment of the present invention of the client side 302 of converged communication content distribution platform 300. In one exemplary embodiment that may be practiced with the present invention, TADS client side 500 includes the TADS Client Protocol Engine 510 that handles all communications using the TADS protocol on the client side for handling transactions, executing applications and accessing services. The client side may also include various TADS client software modules and databases 520.

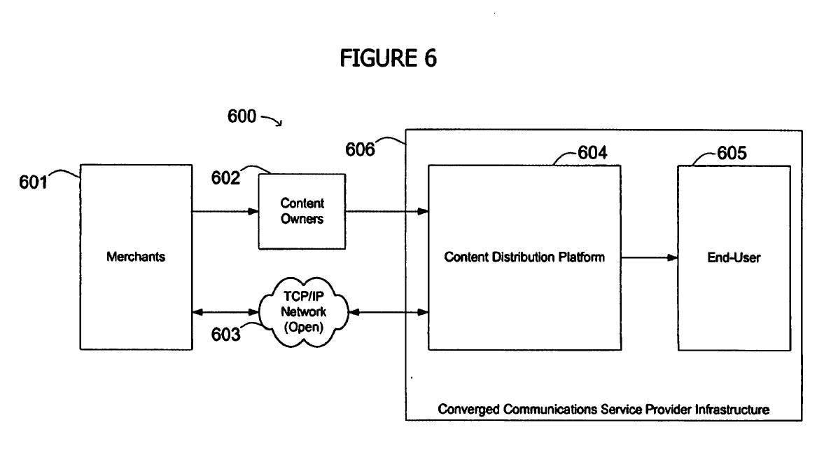

FIG. 6 illustrates an embodiment of the Converged Communications Content Distribution Architecture 600 that provides the distribution of merchant contact information and advertising content with a content distribution platform 604 coupled to and supporting end-user terminals 605, thereby forming a service provider's converged communications infrastructure 606. Content may be provided directly by existing content owners 602 or by the merchants 601 via an open TCP/IP network 603. The architecture 600 identifies five major stakeholders: the merchants 601 that want to make their services and products available to end-users, established content owners 602 that possess basic contact information on the merchants 601, converged communication service providers 606 that provide the closed (“walled garden”) communications infrastructure 604 used to physically exchange information between the merchants 601 and end-users 605, and the owners of the content distribution end-to-end channel (not shown).

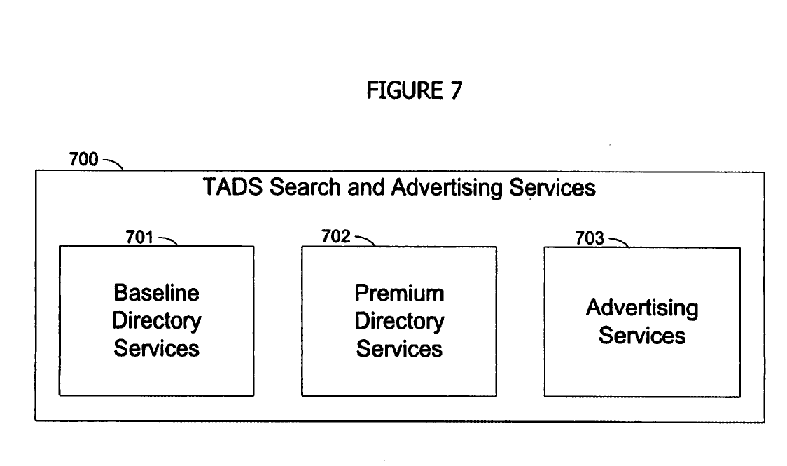

FIG. 7 illustrates TADS Search and Advertising Services 700, which constitute an example class of applications and services that, in one embodiment, may be built on top of the TADS Server Software Modules and Databases 405 and the Telephony Applications 403. These services may be categorized according to Baseline Directory Services 701, Premium Listing Services 702, and Advertising Services 703. These services may also be referred to as subscriber services, since the merchant typically purchases a subscription to publish directory listings with a content publisher. Baseline Directory Services 701 may include, but are not limited to, merchant contact information (name, address, phone numbers, maps, etc.) Premium Directory Services 700 may include, but are not limited to, all the services in the Baseline Directory Services 701, and in addition, top billing of a merchant's contact information in results provided in response to an end-user query (including multimedia content), no-contact transactions (allows end-user to complete a transaction with the merchant without the need to generate a voice call), one-touch calling, and local save to end-user converged communications terminal's address book. Advertising services 703 may include, but are not limited to, all the services in the Baseline Directory Services 701 or all the services in the Premium Directory Services 703, and in addition, the distribution of wall-paper and banner advertisements that can be displayed on the end-user terminal based on specific criteria, including demographics-based algorithms. In one example, advertising services 703 may be acquired without subscribing to directory services 701, 702.

In one illustrative example, Baseline Directory Services 701 may be constructed from existing merchant directory (contact information) content databases provided by the Content Owners 602. Baseline Directory Services 701 may include all end-point views of said information displayed on the end-user terminals 101 and the end-user actions that can be performed on said information. These services may include, but are not limited to, Directory Query, Query Results Local Save, and One-Touch Communications, as described below in detail:

Directory Query: End-user invokes the local search application on the converged communications terminal and enters the required search information (e.g., merchant category and desired location). The end-user query is handled by the Client Protocol Engine and securely submitted to the TADS Server Protocol Engine. Server returns query results to the end-user terminal, providing baseline information (including information such as merchant name, address, phone numbers, and maps) and Premium Directory Services (see below) for all merchant's that match the query specifications. The settlement manager logs all actions associated with the served transaction including, for example, the merchant's actually viewed by the end-user, the merchant's for which the end-user requested more information, the merchant's that were actually contacted by the end-user, and the merchant's for which the end-user responded to premium listing actions.

Query Results Local Save: End-user selects one of the baseline or premium listings returned by a directory query and saves the associated content information into a local entry in their converged communications terminal address book. The Settlement Manager logs the transaction.

One-Touch Communications: End-user selects one of the baseline or premium listings returned by a directory query and initiates a call via the converged communications infrastructure by simply selecting the “one-touch” call feature. The Settlement Manager logs the transaction.

In another example, the Premium Directory Services 702 may be constructed from existing merchant directory (contact information) content databases provided by the Content Owners and additional information provided directly by the merchant. The merchant may interact via the web-based TADS Front-End Console that feeds into the Converged Communications Content Distribution Platform. Premium Listing Services may include, but are not limited to, Top Billing Service of a merchant's contact information, Multimedia Listing Services, and No-Contact Transactions, as described below in detail:

Top Billing Service: Merchants may use the TADS Front-End Console to subscribe to this premium listing service which provides priority placement of a merchant's directory listing. Merchants provide the Converged Communications Content Distribution Platform with contextual information required for the platform to provide merchant priority placement in the presentation of query results to end-users. The contextual information may take the form of both keyword information associated with the Merchant's services and end-user demographic information that the merchant may want included in the determination of whether or not top-billing should be provided to its listing. The Settlement Manager logs all aspects of the transaction.

Multimedia Listing Services: Merchants may use the TADS Front-End Console to subscribe to this premium listing service. Merchants provide the Converged Communications Content Distribution Platform with contextual information required for the platform to provide merchant priority placement in the presentation of query results to end-users as for the Top Billing Service and provide additional multimedia material to be used in accordance to the type of multimedia listing selected by the merchant. For example, the merchant may opt for half-screen or quarter-screen images to be used in presenting its listing. Also, specific multimedia presentations may be presented to the end-user if the merchant's listing is selected by the end-user. The Settlement Manager logs all aspects of the transaction.

No-Contact Transaction: Merchants may use the TADS Front-End Console to enable No Contact Call Service functionality for its premium listings. If an end-user selects a listing with no-contact call service functionality, the TADS server manages the request by prompting the end-user to provide, via the converged communication terminals input interface, all required information to complete a transaction according to the vendor requirements. This effectively allows end-users to complete a transaction with the merchant without the need to generate a voice call. Information is then transferred to the merchant without further end-user intervention (e.g., via e-mail or synthesized voice message). Note that the merchant may be electronically integrated for automated e-commerce, or may simply maintain manual business operations. Upon receipt of the request the merchant takes the appropriate action.

In one illustrative example of a No-Contact Transaction, a premium pizzeria's listing could prompt the user to select amongst a variety of offers. The user would provide the required information pertaining to the offers (for example, pizza size, toppings, crust, etc.) and the Converged Communications Content Distribution Platform would relay the information to the merchant. There would be no need for the end-user to provide address, phone number, and payment information since all of this information would already be available to the Converged Communications Content Distribution Platform Owner through its relationship with the Converged Communications Infrastructure Service Provider Customer Database. The Settlement Manager logs all aspects of the transaction.

The Advertising Services may be constructed from existing merchant directory (contact information) content databases provided by the Content Owners and additional information provided directly by the merchant's via the web-based TADS Front-End Console. The merchant advertisement then feeds into the Converged Communications Content Distribution Platform. Merchants may define distribution and level of exposure for an advertisement using criteria such as user demographics, geographical or organizational boundaries and buying history. Advertising services 703 may include, but are not limited to, the distribution of wall-paper (digital image rendered on the converged communications terminal's display) and video advertisements that can be displayed on the end-user terminal based on specific criteria, including demographics-based algorithms. In one case, the advertisements retains a portion of the end-user terminal's display real-estate. The end-user would have the option of receiving more information on the advertised service or product by simply selecting it via the terminal's input interface. These advertisements would be scheduled and targeted according to the merchant's instructions. The Settlement Manager logs all aspects of the transaction.

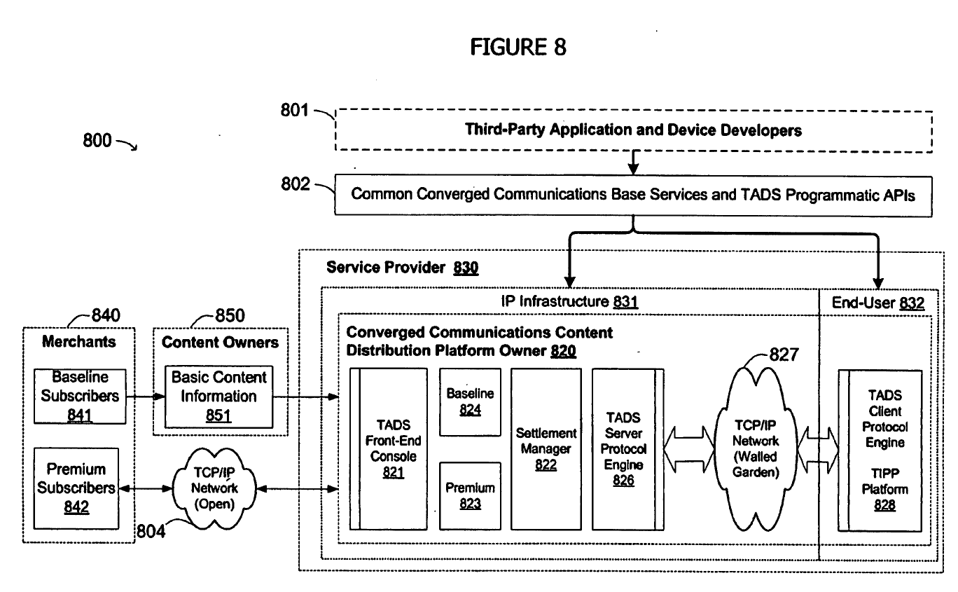

An exemplary method for commercially implementing and embodiment of the Converged Communications Directory Search and Advertising Services 800 is represented in FIG. 8. The Service Provider 830 makes IP infrastructure 831 and the end-user relationships 832 available; the Content owners 850 make their content 851 and local merchant relationships 840 available; and the Converged Communications Content Distribution Platform owner 820 provides the end-to-end distribution channel technology with baseline 824 and premium 823 services. Merchants 840 may include regional and national vendors 841 who make available baseline information 851 to content owners and vendors 842 who make available premium content to end-users 832 via the Transactional Applications Delivery System Front-End Console 821. The former are referred to as Baseline Subscribers 841, while the latter are referred to as Premium Subscribers 842. Merchants 840 may convert to Premium Listings by engaging directly with the Distribution Platform Owner via a Web-based Front End Console 804, 821. The Platform Owner 820 uses the Settlement Manager 822 reports to drive premium subscriber base (by marketing usage and demographic statistics to baseline subscribers.) The server side of the TADS platform includes a protocol engine 826 and is connected to end-users 832 via a walled garden TCP/IP network 827. Additional revenue is enabled via the licensing of the Converged Communication Base Services and TADS Programmatic Application Program Interfaces (APIs) 802 to Third-Party Applications and Device Developers 801. The APIs 802 allow third parties 801 to develop new end-user terminals that can communicate with the TADS server and use TADS-enabled applications and services and to develop new TADS service applications that would be made available to TADS-enabled end-user terminals 832 via the Converged Communications Content Distribution Platform. The method 800 represents one embodiment of the present invention and establishes the lines of responsibilities of each entity in the value chain and the manner in which they interact and share in the per transaction profits.

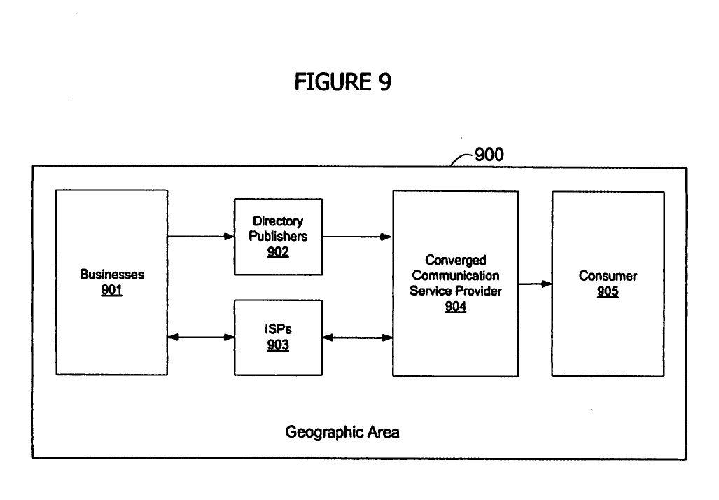

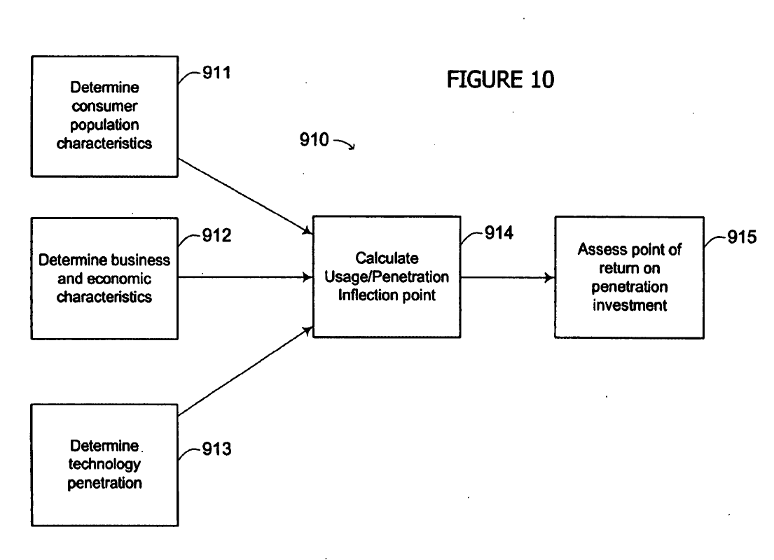

In FIG. 9, a stakeholder view for an installed base in an embodiment of the present invention is illustrated. The stakeholders in a given geographic area 900 may comprise businesses 901, directory publishers 902, Internet Service Providers (e.g. high-speed cable or DSL access) 903, providers of converged communication services and infrastructure 904, and consumers 905. The stakeholder view for a given geographic area is useful in implementing the method for roll-out and market penetration of the present invention, as shown in FIG. 10. The method for roll-out and market penetration may involve a demographic analysis 910 of a given geographic area 900.

Monetization of device-based media must have critical mass and critical density of users in a given geographic area. Large numbers of users with low density provides insufficient usage and will not be relevant in the local business community. High penetration of relatively small universes may have high value, but not every universe can be effectively monetized. This methodology encompasses a measurement of a macro or micro set of a known universe of users to determine optimal distribution based on likely usage which directly impacts monetization. The method establishes, on a discrete universe basis, necessary penetration of devices that create a point of inflection on usage and distribution that produce a tipping point of relevancy at which local businesses must consider to self-include because of the business opportunity. Merely distributing devices without multiple factors will not allow for the medium to have significant usage, relevance, ergo revenue and profit.

In calculating the scope of a distribution plan, the known-universe and penetration of that universe, adjusted by the nature of the community (transient or sedentary) must be established. Super neighborhoods and micro universes can be monetized based on the likely residents with more transient/temporary residents having the highest potential monetization based on the likelihood of use of the device because of lack of geographical awareness. For example tourist areas, where the tourist population is likely to exceed the indigenous population may offer high monetization potential. Consequently, relevance to advertisers is higher based on the likelihood of residents of a particular universe to utilize the content to make selections of vendors of goods and services.

While dense populations of high income and high broadband penetration is relevant and has impact, those factors must be scaled by geographic and sociological factors including, but not limited to, nature of surrounding employment and businesses, nature of preferred transportation of the residents, and number of businesses in the universe. Fewer businesses per capita in an area of high income provide a lower monetization opportunity than a median income universe with high density of businesses per capita. Broadly distributed business communities have greater value than clustered businesses in a central business area. Geographic mass must be scaled as part of the methodology to measure the propensity of the residents of the universe to travel to find service and goods in addition to find local employment.

Additionally, the methodology will establish the point of diminishing return at what more devices do not measurably impact adoption or relevance, creating saturation with little incremental monetization opportunity.

In order to monetize the services embodied by the present invention, it is important to adhere to a scientifically determined geographic distribution process, since the value of local advertising to merchants will depend on the penetration of end-terminals into their geographic area of influence. One analysis step 911 may involve determining the characteristics of the consumer population in a given geographic area. This determination 911 may comprise the following relevant demographic criteria: size of area; population density; density of housing; and mass of population (clustering of population centers). A further analysis step 912 may involve determining the characteristics of business and economic activities in the geographic area, such as: available modes of transportation; number and density of businesses; mass of business (clusters of business centers); economics of geography; buying patterns; and elasticity of economic demand. A further analysis step 913 may involve determining the broadband penetration of the geographic area, such as: availability of high-speed Internet; penetration of high-speed Internet; density of usage for all media or interactive media; user familiarity of digital content; and mass distribution of users. A further step 914 may involve combining the quantitative factors determined in steps 911-913, to determine the usage or penetration inflection point, such that a critical mass of converged communications usage occurs. A further step 915 may involve using a demographic usage model to determine the return on the investment, in view of the infrastructure required to engage stakeholders, as shown in FIG. 9. Thus the method of 910 may be practiced for revealing geographic areas where economic factors are auspicious for a market penetration of the converged communications system of the present invention.

Although the method, computer program product and system are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims.

What is claimed is:

1. A method for converged communications content distribution comprising:
providing converged communications service to a plurality of end users from a client side of a digital content distribution platform;
publishing content to said content distribution platform, wherein a content owner provides said content on a server side of said digital content distribution platform;
providing subscriber information to said content owner by a merchant; and
providing bidirectional, converged communications from said server side of said content distribution platform to said merchant, wherein each of said plurality of end users is enabled for converged communications with said merchant.

2. The method as recited in claim 1, wherein said publishing step further comprises using a front-end console interface for uploading said content.

3. The method as recited in claim 1, wherein said client side comprises client side elements;
and said server side comprises server side elements.

4. The method as recited in claim 3, wherein said client side elements and said server side elements are networked as a closed TCP/IP network segment, and wherein a plurality of converged communication terminals are configured as network clients on said closed TCP/IP network segment.

5. The method as recited in claim 3, wherein said server side elements further comprise search and advertising services.

6. A method as recited in claim 5, wherein said search and advertising services further comprise:
baseline subscriber directory services;
premium subscriber directory services; and
advertising services.

7. The method as recited in claim 6, wherein said baseline subscriber directory services further comprise the following client side operations:
querying the content of a directory using an electronic search application;
returning and displaying the result of a search query to said converged communication terminal, wherein said result comprise a plurality of merchant directory listings;
initiating a call to a merchant with a “one-touch” selection of a merchant directory listing on said converged communication terminal;
printing the results of a directory query from said converged communication terminal;
storing the results of a directory query in a memory coupled to said converged communication terminal; and
retrieving the results of a previously executed directory query from a memory coupled to said converged communication terminal,
and further comprise the following server side operations:
billing a merchant for said baseline subscriber directory services;
providing the content of the baseline display of a merchant's directory listing;
logging all activity performed on said converged communication terminal by an end user in an activity log; and
retrieving a plurality of activity logs and generating a statistical report of activity performed by said server side elements.

8. A method as recited in claim 7, wherein said merchant directory listing comprises:
a merchant name;
a merchant address;
a merchant phone number;
a link to a merchant web-site;
a text message; and
a map to a merchant business location.

9. The method as recited in claim 6, wherein said premium subscriber directory services comprise said baseline subscriber directory services, and further comprise the following client side operations:
placing an order with a merchant by using said converged communication terminal as a data input device; and
providing payment information to a merchant by using said converged communication terminal as a data input device; and
authorizing a payment to a merchant by using said converged communication terminal as a data input device,
and further comprise the following server side operations:
billing a merchant for said premium subscriber directory services;
providing the content of the premium display of a merchant's directory listing; and
providing the content of the multimedia display of a merchant's directory listing.

10. A method as recited in claim 6, wherein said advertising services comprise said premium subscriber directory services or said baseline subscriber directory services, and further comprise the following client side operations:
displaying a multimedia advertisement for a merchant on said converged communication terminal,
and further comprise the following server side operations:
providing the multimedia content of a merchant's advertisement;
defining the distribution and level of exposure of a merchant's advertisement;
scheduling and displaying a merchant's advertisement; and
billing a merchant for displayed advertising.

11. The method for determining if a geographic area can support a converged communications content distribution system, comprising the steps of:
determining consumer population characteristics of said geographic area;
determining business and economic characteristics of said geographic area;
determining the technology infrastructure penetration of said geographic area;
calculating an inflection point where usage of said converged communications content distribution system increases dramatically; and
assessing the point of return on investment required for penetrating said geographic area with said converged communications content distribution system.

12. A system for converged communications content distribution comprising:
circuitry for providing converged communications service to a plurality of end users from a client side of a digital content distribution platform;
circuitry for publishing content to said content distribution platform, wherein a content owner provides said content on a server side of said digital content distribution platform;
circuitry for providing subscriber information to said content owner by a merchant; and
circuitry for providing bidirectional, converged communications from said server side of said content distribution platform to said merchant, wherein each of said plurality of end users is enabled for converged communications with said merchant.

13. The system of claim 12, wherein said circuitry for publishing further comprises circuitry for using a front-end console interface for uploading said content.

14. The system of claim 12, wherein said client side is operable for client side elements; and said server side is operable for server side elements.

15. The system of claim 14, wherein said client side elements and said server side elements are networked as a closed TCP/IP network segment, and wherein a plurality of converged communication terminals are configured as network clients on said closed TCP/IP network segment.

16. The system of claim 14, wherein said server side elements further comprise circuitry for search and advertising services.

17. A system of claim 16, wherein said circuitry for search and advertising services further comprises:
circuitry for baseline subscriber directory services;
circuitry for premium subscriber directory services; and
circuitry for advertising services.

18. The system of claim 17, wherein said circuitry for baseline subscriber directory services further comprises the following circuitry for client side operations:
circuitry for querying the content of a directory using an electronic search application;
circuitry for returning and displaying the result of a search query to said converged communication terminal, wherein said result comprise a plurality of merchant directory listings;
circuitry for initiating a call to a merchant with a “one-touch” selection of a merchant directory listing on said converged communication terminal;
circuitry for printing the results of a directory query from said converged communication terminal;
circuitry for storing the results of a directory query in a memory coupled to said converged communication terminal; and
circuitry for retrieving the results of a previously executed directory query from a memory coupled to said converged communication terminal, and further comprise the following circuitry for server side operations:
circuitry for billing a merchant for said baseline subscriber directory services;
circuitry for providing the content of the baseline display of a merchant's directory listing;
circuitry for logging all activity performed on said converged communication terminal by an end user in an activity log; and
circuitry for retrieving a plurality of activity logs and generating a statistical report of activity performed by said server side elements.

19. A method of claim 18, wherein said merchant directory listing comprises:
a merchant name;
a merchant address;
a merchant phone number;
a link to a merchant web-site;
a text message; and
a map to a merchant business location.

20. The system of claim 17, wherein said circuitry for premium subscriber directory services comprises said circuitry for baseline subscriber directory services, and further comprises the following circuitry for client side operations:
circuitry for placing an order with a merchant by using said converged communication terminal as a data input device; and
circuitry for providing payment information to a merchant by using said converged communication terminal as a data input device; and
circuitry for authorizing a payment to a merchant by using said converged communication terminal as a data input device, and further comprises the following circuitry for server side operations:
circuitry for billing a merchant for said premium subscriber directory services;
circuitry for providing the content of the premium display of a merchant's directory listing; and
circuitry for providing the content of the multimedia display of a merchant's directory listing.

21. A system of claim 17, wherein said circuitry for advertising services comprise said circuitry for premium subscriber directory services or said circuitry for baseline subscriber directory services, and further comprises the following circuitry for client side operations:
circuitry for displaying a multimedia advertisement for a merchant on said converged communication terminal,
and further comprises the following circuitry for server side operations:
circuitry for providing the multimedia content of a merchant's advertisement;
circuitry for defining the distribution and level of exposure of a merchant's advertisement;
circuitry for scheduling and displaying a merchant's advertisement; and
circuitry for billing a merchant for displayed advertising.
